(19) United States
(12) Patent Application Publication
(10) Pub. No.: US 2009/0051514 A1
(43) Pub. Date: Feb. 26, 2009

(54) Car Collision Global Positioning System

(75) Inventor: Ahmed Al-Sayegh, Kuwait City (KW)

Correspondence Address: FURR LAW FIRM, 2622 DEBOLT ROAD, UTICA, OH, 43080, US

(73) Assignee: University of Kuwait, Safat (KW)

(21) Appl. No.: 11/844,500

(22) Filed: Aug. 24, 2007

(51) Int. Cl. B60Q 1/52; G01C 21/00

(52) U.S. Cl. 340/436; 701/213

(57) ABSTRACT

The present invention relates to a device and system to inform people and relevant authorities about the place of a traffic accident at the time they occur in order for required assistance to get there as soon as possible. The device transmits messages in frequencies to relevant authorities for emergencies when a road traffic accident has occurred. Sometime this happens in a remote or uninhabited area where the driver may lose his conscience or is seriously injured and he cannot inform the authorities about it and there is nobody to inform about him. This device is very useful in traveled road and prairies. The device is operated by an accurate micro switches. Which are distributed accurately throughout the vehicle. These are not operated unless the accident is very strong or the vehicle is overturned.

### BACKGROUND OF INVENTION

The present invention relates to a Global Positioning device more particular a device that gives the location when there has been an accident.

### 1. BACKGROUND

There exists a need for emergency crews to know when and where there has been an accident. There has been devices that use mobile phones as a means to transmit rescue signal but this does not always work because the person in the accident may be out side of the coverage area of the telecommunications system.

Other have used navigational image screens which are very expensive and not available in all cars. Also these systems rely on map which can change from time to time.

Some systems use other devices to determine the driver's condition such as blood pressure, temperature, heart pulse. These do not always work right in accident situations and can be very expensive.

Other systems depend on the car's dynamo where the car's electricity may be disconnected.

### PRIOR ART REFERENCE AND DISCUSSION

U.S. Pat. No. 7,119,669 by Lundsgaard, et al. and issued on Oct. 10, 2006 is for a method and apparatus for detecting vehicular collisions. It discloses a portable electronic device, like a cellular telephone is capable of detecting collisions between vehicles and notifying the proper authorities. The device includes a microprocessor and memory, in addition to an accelerometer and global positioning systems receiver. The memory includes at least one filter for screening out false positives, which are false collision detections. In one embodiment, the device determines its velocity. It then checks to see if its velocity falls within a range associated with moving vehicles. If so, the device monitors the accelerometer. When acceleration values in excess of a predetermined threshold are detected, the device pauses and again checks its velocity. If the velocity has fallen from the range associated with moving vehicles to a range associated with a vehicle that has sustained a collision, the device notifies emergency personnel that a collision has occurred.

U.S. Pat. No. 6,922,137 by Bycroft and issued on Jul. 26, 2005 is for a collision and theft alert system. It discloses a collision and theft alert system comprising several components in combination. First provided is a vehicle having a keypad and a power source. A processor is operatively coupled to the power source and to the keypad and is capable of receiving an incoming signal and sending an outgoing signal. The processor can activate an emergency distress call with GPS location. The processor also is operatively coupled to and activates at least one strobe light, which is operatively coupled to the vehicle. The strobe light has a non-deployed state and a deployed state.

U.S. Pat. No. 6,487,500 by Lemelson, et al. and issued on Nov. 26, 2002 is for a GPS vehicle collision avoidance warning and control system and method. It discloses a GPS satellite ranging signals received on comm1, and DGPS auxiliary range correction signals and pseudolite carrier phase ambiguity resolution signals from a fixed known earth base station received on comm2, at one of a plurality of vehicles/aircraft/automobiles are computer processed to continuously determine the one's kinematic tracking position on a pathway with centimeter accuracy.

There is room for improvement in the art.

### SUMMARY OF INVENTION

The present invention relates to a device and system to inform people and relevant authorities about the place of a traffic accident at the time they occur in order for required assistance to get there as soon as possible.

The device transmits messages in frequencies to relevant authorities for emergencies when a road traffic accident has occurred. Sometime this happens in a remote or uninhabited area where the driver may lose his conscience or is seriously injured and he cannot inform the authorities about it and there is nobody to inform about him. This device is very useful in traveled road and prairies. The device is operated by an accurate micro switches. Which are distributed accurately throughout the vehicle. These are not operated unless the accident is very strong or the vehicle is overturned.

It is an object of this invention to inform the relevant authorities by estimating the location of the traffic accident at the time it occurs.

### BRIEF DESCRIPTION OF DRAWINGS

Without restricting the full scope of this invention, the preferred form of this invention is illustrated in the following drawings:

FIG. 1 the process of the invention;

FIG. 2 shows the components of the device;

FIG. 3 shows proposed locations of the micro switches;

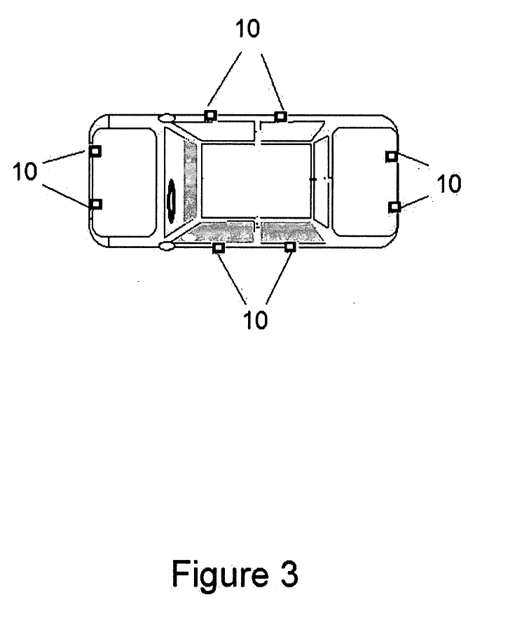

FIG. 4 shows the transmission process;

FIG. 5 shows the mercury connector; and

FIG. 6 shows the micro switch

### DETAILED DESCRIPTION

The following description is demonstrative in nature and is not intended to limit the scope of the invention or its application of uses.

The present invention relates to a device and process to inform people and relevant authorities about the place of a traffic accident at the time they occur in order for required assistance to get there as soon as possible.

The device 1 transmits messages in frequencies to relevant authorities for emergencies when a road traffic accident has occurred. Sometime this happens in a remote or uninhabited area where the driver may lose his conscience or is seriously injured and he cannot inform the authorities about it and there is nobody to inform about him. This device 1 is very useful in traveled road and prairies. The device 1 is operated by a plurality of accurate micro switches 10 which are distributed accurately throughout the vehicle. These are not operated unless the accident is very strong or the vehicle is overturned.

The purpose of the device 1 is the quick notification of the accident resulting in the quick arrival of emergency assistance.

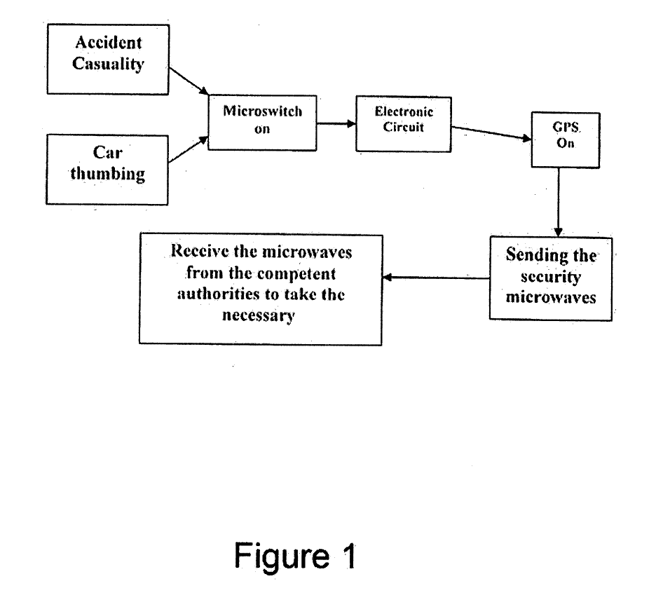

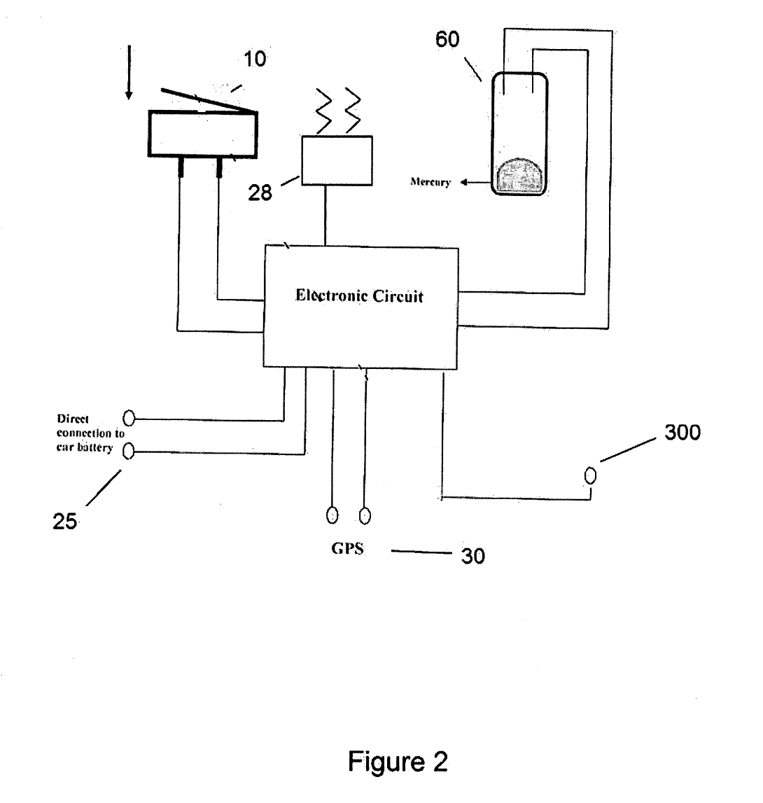

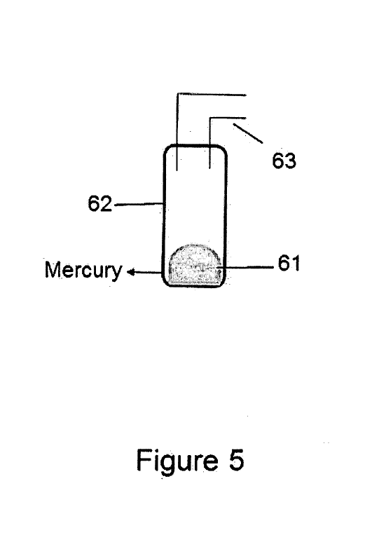

The device 1 will notify emergency personnel if there is direct damage to the vehicle's body in the front, rear or to one of the sides or where the vehicle overturns. As shown in FIG. 1, the device 1 will consist of a number of micro switches distributed throughout the vehicle 100. In the preferred embodiment there will be eight micro switches in total, 2 on the front, 2 on the back, and 2 on each of the sides. This is shown in FIG. 2. The micro switches 10 will be connected to the electronic circuit 20 which is a computer processor in the preferred embodiment. The electronic circuit 20 is connected to a power source 25 which in the preferred embodiment is the vehicle's battery for power. The electronic circuit 20 is connected to a GPS system 30 which will give the vehicle's location. The electronic circuit 20 will be connected to the vehicles airbag system 300. The mercury switches 60 are also connected to the electronic circuit 20. The mercury switches 60 have a point of connection so that when an overturn occurs the mercury completes a connection. The mercury 61 is in a enclosed holder 62 with two connecting wires 63 sticking out of the top on of the holder as shown in FIG. 5.

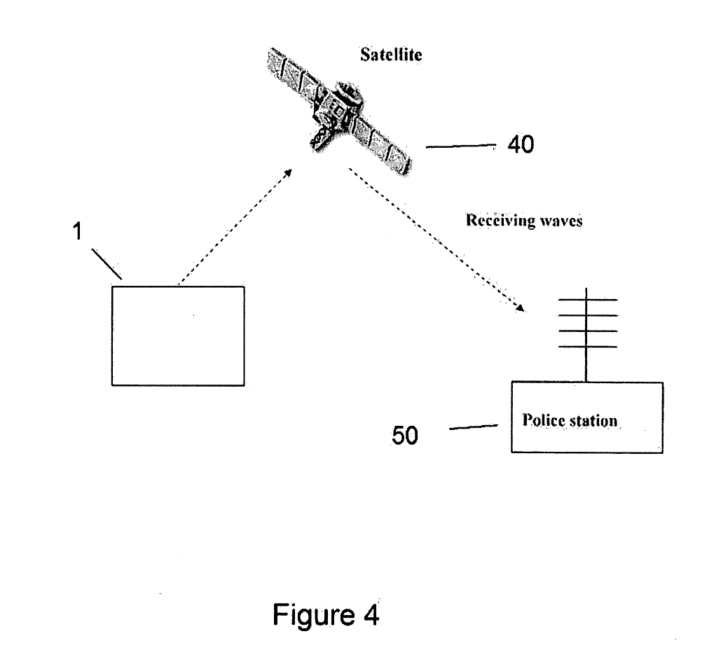

As, shown in FIG. 1, when there is direct damage to the vehicle micro switches 10 in the vehicle's body 75 will switch on. As shown in FIG. 4, this will be communicated to the device's electronic circuit 20 which can be a central processor which will read the GPS system 30 for the vehicle's locations. The electronic circuit 20 will then transmit this information using a transmitter 28 by electromagnetic wave to a satellite 40 which will re-transmit the information to a receiving location 50 which will notify the proper authority such as the police or emergency workers on what to do.

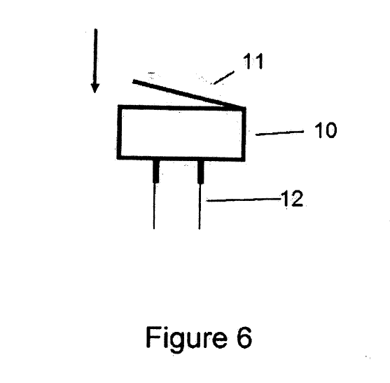

The micro switches 10 are shown in FIG. 6. The micro switches 10 have a key 11 that when closed due to an accident connects the circuit between two wires 12 and sending a signal to the electronic circuit 20. For a vehicle overturning, the device 1 will have mercury switches 60 which will be switched on when the car overturns. As shown in FIG. 4, this will be communicated to the device's electronic circuit 20 which can be a central processor which will read the GPS system 30 for the vehicle's locations. The electronic circuit 20 will then transmit this information using a transmitter 28 using electromagnetic waves to a satellite 40 which will re-transmit the information to a receiving location 50 which will notify the proper authority such as the police or emergency workers on what to do.

If the air bag system 300 goes off it will send a signal to the electronic circuit 20. As shown in FIG. 4, this will be communicated to the device's electronic circuit 20 which can be a central processor which will read the GPS system 30 for the vehicle's locations. The electronic circuit 20 will then transmit this information using a transmitter 28 using electromagnetic waves to a satellite 40 which will retransmit the information to a receiving location 50 which will notify the proper authority such as the police or emergency workers on what to do.

In an alternative embodiment, the electronic circuit can have its own power source such as a chargeable battery in case the battery to the vehicle stops working.

The device 1 does not rely on mobile phones and signals in the preferred embodiment as there may be no coverage for this type of communication. Microwaves are the preferred method of communication. It does not rely on a person reporting the accident since the driver and passengers may be incapacitated. It does not reply on other people to move the report because they may not be anyone to make the report. It does not rely on navigation maps are these may not be accurate.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A device to notify when a can is in a accident comprising;
a electronic circuit connected to sensor connected to the vehicle where said electronic circuit is connected to a power source and is connected to a GPS where said electronic circuit sends a transmission with the GPS location if the sensors indicant that the vehicle has been in an accident.

2. A device according to claim 1, wherein said sensors are a plurality of micro switches.

3. A device according to claim 1, wherein said sensors are a plurality of mercury switches.

4. A device according to claim 1, wherein said electronic circuit is connected to an air bag system.

5. A device according to claim 1, wherein said sensors are a plurality of micro switches and mercury switches.

6. A device according to claim 1, wherein said transmission is sent to a satellite which resends the transmission to a receiving location.

7. A device according to claim 3, wherein said mercury switches are a container with mercury in them with two wires in the top of said container where said mercury will complete the circuit between the two wires if the vehicle is overturned.

8. A device according to claim 2, wherein said micro switches are positioned on the front, back and sides of the vehicle.

9. A device according to claim 2, wherein said micro switches have a have a key that closes when an accident closing a circuit between two wires.

10. A device according to claim 1, wherein said transmission is a microwave transmission.

11. A process to notify when a can is in a accident comprising;
having a electronic circuit connected to sensor connected to the vehicle where said electronic circuit is connected to a power source and is connected to a GPS and having said electronic circuit sending a transmission with the GPS location if the sensors indicant that the vehicle has been in an accident.

12. A process according to claim 11, wherein said sensors are a plurality of micro switches.

13. A process according to claim 11, wherein said sensors are a plurality of mercury switches.

14. A process according to claim 11, wherein said electronic circuit is connected to an air bag system.

15. A process according to claim 11, wherein said sensors are a plurality of micro switches and mercury switches.

16. A process according to claim 11, having said transmission sent to a satellite which resends the transmission to a receiving location.

17. A process according to claim 13, wherein said mercury switches are a container with mercury in them with two wires in the top of said container where said mercury will complete the circuit between the two wires if the vehicle is overturned.

18. A process according to claim 12, wherein said micro switches are positioned on the front, back and sides of the vehicle.

19. A process according to claim 12, wherein said micro switches have a have a key that closes when an accident closing a circuit between two wires.

20. A process according to claim 11, wherein said transmission is a microwave transmission.
